(19) United States
(12) Patent Application Publication
(10) Pub. No.: US 2022/0129491 A1
(43) Pub. Date: Apr. 28, 2022

(54) METHOD FOR SUPPORTING AGENT AND COMPUTING DEVICE THEREOF

(71) Applicant: Coupang Corp., Seoul (KR)

(72) Inventors: Jeong Hun Lee, Seoul (KR); Hye Jin Kim, Seoul (KR); Cho Rong Kim, Seoul (KR); Mi Sun Lim, Seoul (KR); Yoo Jung Jo, Seoul (KR); Eun Sol Kim, Seoul (KR); So Yeon Son, Seoul (KR); Sang Gwee Bae, Seoul (KR); Han Na Kang, Seoul (KR)

(21) Appl. No.: 17/155,648

(22) Filed: Jan. 22, 2021

(30) Foreign Application Priority Data
Oct. 22, 2020 (KR) 10-2020-0137661

(51) Int. Cl. G06F 16/338; G06F 16/31; G06F 16/38; G06F 16/335; G06Q 10/06

(52) U.S. Cl. CPC G06F 16/338; G06F 16/313; G06Q 10/063112; G06F 16/335; G06F 16/38

(57) ABSTRACT

According to the present disclosure, an agent support method including acquiring information on or regarding at least one keyword related to counseling, identifying information on or regarding an index corresponding to the at least one keyword, and displaying a title related to a counseling record and an answer content list related to the index based on the information on the index and a computing device thereof is provided.

### BACKGROUND

### Technical Field

This disclosure relates to an agent support method for supporting an agent conducting counseling with a customer and a computing device thereof.

### Description of the Related Art

With developments of electronic technologies, e-commerce has become a field of shopping. Customers can buy products online without needing to visit shopping malls or markets in person. The products purchased online are delivered to destinations requested by the customers.

Various online shopping malls based on e-commerce operate customer service centers (e.g., call centers) to deal with customer's inquiries or problems caused in relation to e-commerce. A customer contacts an agent of the customer service center in a wireless or wired manner to be counseled about e-commerce. The agent providing the counseling service may be a person who is trained to listen to the customer and provide an appropriate answer.

Typically, the agent has performed counseling by listening to the customer, searching for related content from a database containing a vast amount of data, and providing the findings to the customer. However, in this case, it takes a long time to provide the appropriate answer to the customer because an efficiency of a counselor's counseling process is relatively low, which may lead to the user's inconvenience. Accordingly, there is a desire for a method of supporting an agent to more efficiently provide a counseling service.

### SUMMARY

### Technical Goals

An aspect is to provide an agent support method that provides answer content based on index information corresponding to at least one keyword related to counseling in order to quickly and efficiently conduct the counseling, and a computing device thereof.

Technical goals to be achieved by the present embodiments are not limited to the above-described technical tasks and may further include other technical tasks.

### Technical Solutions

According to a first embodiment, there is provided a method of supporting an agent via a computing device, the method including acquiring information on or regarding at least one keyword related to counseling, identifying information on or regarding an index corresponding to the at least one keyword, and displaying a title related to a counseling record and an answer content list related to the index based on the information on the index.

According to a second embodiment, there is also provided a non-transitory computer-readable recording medium including a computer program for performing a method of supporting an agent via a computing device, the method including acquiring information on at least one keyword related to counseling, identifying information on an index corresponding to the at least one keyword, and displaying a title related to a counseling record and an answer content list related to the index based on the information on the index.

According to a third embodiment, there is also provided a computing device for supporting an agent, the device including a memory including instructions and a processor, wherein the processor is connected to the memory and configured to acquire information on at least one keyword related to counseling, identify information on an index corresponding to the at least one keyword, and display a title related to a counseling record and an answer content list related to the index based on the information on the index.

Details of other embodiments are included in the detailed description and the accompanying drawings.

### Effects

According to example embodiments, an agent support method and a computing device thereof may provide an answer content list for giving an answer during counseling based on information on or regarding an index identified based on at least one keyword related to the counseling. Through this, the counseling may be conducted with increased efficiency and speed, thereby improving a customer's satisfaction and efficiency of counseling tasks.

Further, according to example embodiments, an agent support method and a computing device thereof may provide an answer content list based on identification information of an agent and support the agent to smoothly conduct counseling based on characteristics of the agent so that counseling tasks are effectively performed.

Further, according to example embodiments, it is possible to support an agent to provide at least a predetermined level of guidance in various environments by adaptively adjusting information provided to the agent based on characteristics of the agent and a customer.

Effects of the present disclosure are not limited to the effects mentioned above and other effects not mentioned will become apparent to those skilled in the art from the description of the claims.

### BRIEF DESCRIPTION OF THE DRAWINGS

FIG. 1 is a diagram illustrating an agent support method according to an example embodiment.

FIG. 2 is a functional block diagram illustrating a computing device for supporting an agent according to an example embodiment.

FIG. 3 is a flowchart illustrating an agent support method according to an example embodiment.

FIG. 4 is a diagram illustrating an example of acquiring a plurality of keywords wherein at least one keyword related to an agent support method is provided in plural according to an example embodiment.

FIG. 5 is a diagram illustrating an example of identifying an index wherein at least one keyword related to an agent support method is provided in plural according to an example embodiment.

FIG. 6 is a diagram illustrating an example of displaying a title related to a counseling record and an answer content list wherein at least one keyword related to an agent support method is provided in plural according to an example embodiment.

FIG. 7 is a diagram illustrating an example of displaying answer content wherein at least one keyword related to an agent support method is provided in plural according to an example embodiment.

FIG. 8 is a diagram illustrating an example of acquiring a keyword wherein at least one keyword related to an agent support method is provided as a single keyword according to an example embodiment.

FIG. 9 is a diagram illustrating an example of identifying an index wherein at least one keyword related to an agent support method is provided as a single keyword according to an example embodiment.

FIG. 10 is a diagram illustrating an example of displaying a title related to a counseling record and an answer content list when at least one keyword related to an agent support method is provided as a single keyword according to an example embodiment.

### DETAILED DESCRIPTION FOR CARRYING OUT THE INVENTION

Terms used in embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element.

Throughout the specification, the expression “at least one of A, B, and C” may include the following meanings: A alone; B alone; C alone; both A and B together; both A and C together; both B and C together; and all three of A, B, and C together.

The term “computing device” mentioned below may also be referred to as an “electronic device” and may be implemented as a computer or a portable terminal capable of accessing a server or another terminal through a network. Here, the computer may include, for example, a laptop computer, a desktop computer, and a notebook equipped with a web browser. The portable terminal may be a wireless communication device ensuring a portability and a mobility, and include any type of handheld wireless communication device, for example, a tablet PC, a smartphone, a communication-based terminal such as international mobile telecommunication (IMT), code division multiple access (CDMA), W-code division multiple access (W-CDMA), and long term evolution (LTE).

In the following description, embodiments of the present disclosure will be described in detail with reference to the drawings so that those skilled in the art can easily carry out the present disclosure. However, the present disclosure may be implemented in various different forms but it is not limited to the exemplary embodiments described herein.

Hereinafter, example embodiments of the present disclosure will be described with reference to the drawings.

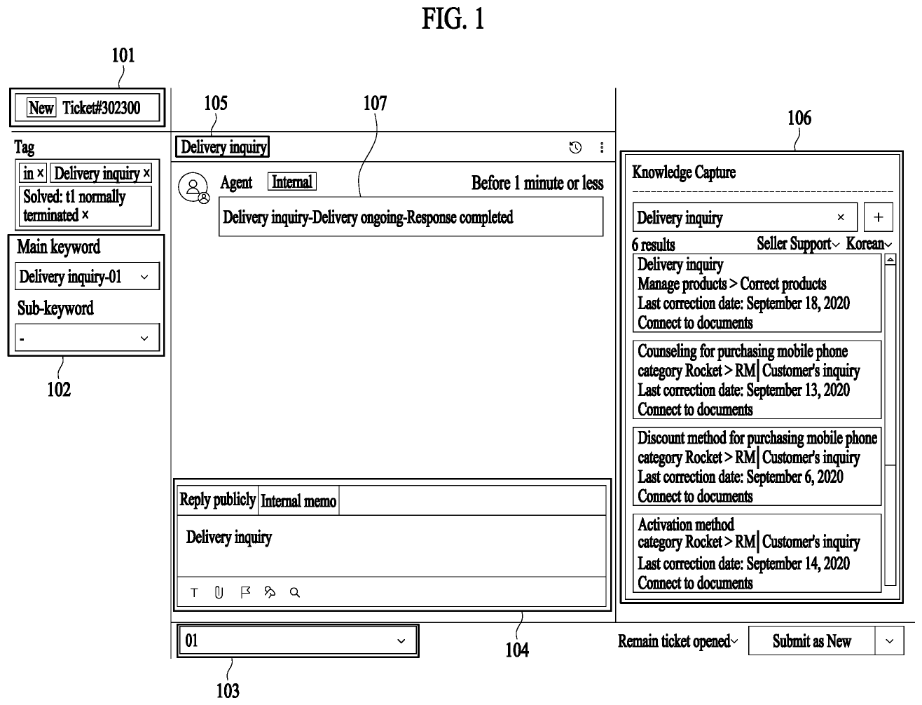

FIG. 1 is a conceptual diagram illustrating an agent support method according to an example embodiment. Specifically, FIG. 1 is a diagram illustrating a method of supporting counseling of an agent when the agent conducts the counseling in response to a customer's counseling request.

In the example embodiment, FIG. 1 illustrates a screen displayed on a device used by the agent in response to a counseling request being received from a customer, for example, a computing device for agent support. Referring to FIG. 1, when the counseling request is received from the customer, a page for generating a counseling record may be generated so that newly generated counseling information 101 is displayed on the device of the agent. As shown in FIG. 1, the counseling information 101 may include a counseling number, for example, “302300” indicating the counseling and a text “new” indicating that the counseling is new.

In the example embodiment, the computing device may receive an input of a keyword related to the counseling based on an input of the agent. The computing device may acquire information on or associated with at least one keyword related to the counseling based on the input of the keyword. The keyword may be a word representing the counseling and may include, for example, “delivery inquiry” of FIG. 1. In an example embodiment, the keyword may be a word derived by the agent confirming an inquiry from the customer as the counseling begins. In another example embodiment, the computing device may input a keyword in response to the keyword being received from a device used by the customer.

The computing device may identify information on or associated with an index based on an acquisition of information on or associated with the keyword. The index may be designated for each keyword. Also, the index may be composed of at least one of, for example, numbers, characters, and symbols but not be limited thereto. For example, an identifier corresponding to the keyword may be the index. The index may correspond to, for example, “01” as shown in FIG. 1.

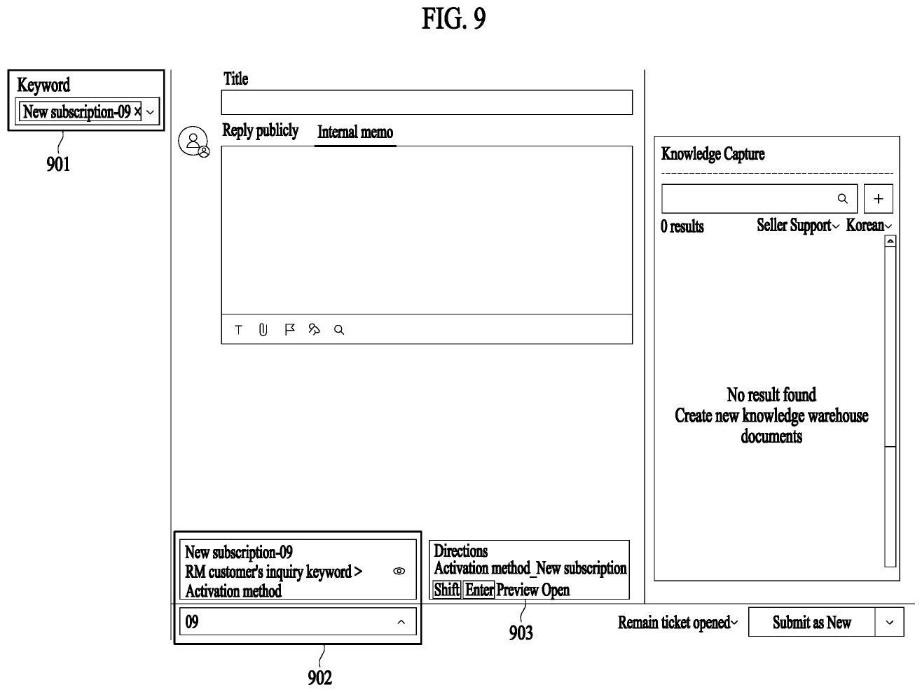

In the example embodiment, referring to FIG. 1, the keyword and the index may be displayed in a predetermined area of the screen displayed on the computing device. The predetermined area 102 may be displayed in a form of selecting a keyword and an index corresponding to the index from a list presented as a drop-down type menu. Depending on an embodiment, the displaying of the index may be omitted. In addition, when a single keyword is input as illustrated, an indication “main keyword” of the predetermined area 102 may be presented as “keyword” and an indication “sub-keyword” and a corresponding input field may be omitted. A related example is described in greater detail with reference to FIG. 9.

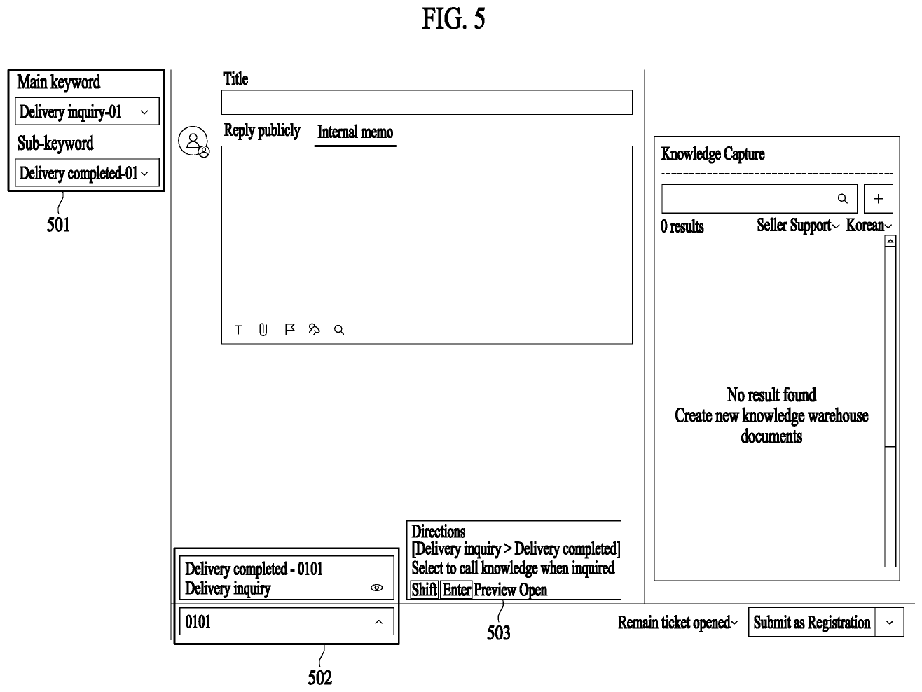

Although not shown, in some cases, the computing device may receive a plurality of keywords, for example, a main keyword and a sub-keyword. In such cases, the computing device may acquire information on or regarding the plurality of keywords in response to the plurality of keywords being input. In addition, each of the plurality of keywords may be displayed in at least a portion of the predetermined area 102 of FIG. 1. A related example is described in greater detail with reference to FIG. 5.

In the example embodiment, when the keyword includes a plurality of keywords, an index 103 may be determined based on an index corresponding to each of the plurality of keywords. A related example is described in greater detail with reference to FIG. 5.

In the example embodiment, the computing device may generate a counseling history based on an identification of the index 103. In an example, the computing device may generate a counseling history with content corresponding to the index 103 in accordance with the index 103 being identified. Depending on a case, the counseling history may include a keyword but may not be limited thereto. As an example, when the keyword is a “delivery inquiry”, a counseling history may include the text “delivery inquiry.” As another example, when the keyword is “delivery inquiry”, a counseling history may include the text “customer inquired about delivery of product at **:**.” In this case, time information associated with the counseling history and information on or regarding the product related to the counseling may be information acquired in advance.

In the example embodiment, the counseling history may be generated in a memo area 104 of FIG. 1, and it is merely an example.

In the example embodiment, the computing device may display a title 105 related to the counseling history based on the index. A representative word indicating the counseling may be designated as the title 105. For example, the computing device may display the title 105 as “delivery inquiry.” However, it is merely an example, and the title 105 may be displayed as “delivery” or “product.” The text displayed as the title 105 may be previously designated to correspond to the index.

In the example embodiment, the computing device may display an answer content list 106 based on the identification of the index 103. An answer content list may be the list 106 including answer content to be provided to the customer based on the counseling. The answer content list 106 may be previously designated to correspond to the index 103.

As such, a portion of a counseling history may be partially completed automatically in a system in accordance with the identification of the index corresponding to the keyword, whereby the agent may create the counseling record with an increased ease.

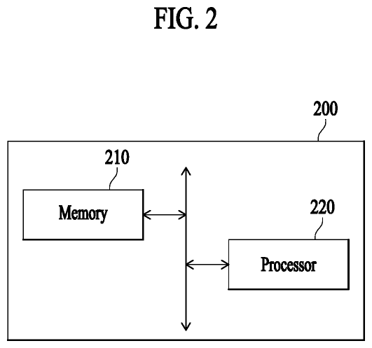

FIG. 2 is a functional block diagram illustrating a computing device for supporting an agent according to an example embodiment. FIG. 2 illustrates only components related to the present embodiment. However, it is apparent to those skilled in the art that other general-purpose components may be further included in addition to the components illustrated in FIG. 2.

Referring to FIG. 2, a computing device 200 may include a memory 210 and a processor 220. Each element illustrated in FIG. 2 may be a unit that processes at least one function or operation and may be implemented through hardware, software, or a combination of hardware and software.

Depending on an embodiment, the computing device 200 of FIG. 2 may be implemented as a server, a computer, or a terminal. However, the present specification is not limited by an implementation of the computing device 200.

The memory 210 may store a variety of data associated with the computing device 200. As an example, the memory 210 may store at least one instruction for an operation of the computing device 200. In this example, the processor 220 may perform various operations based on the instruction stored in the memory 210 as described below.

In the example embodiment, the memory 210 may store a keyword and an index corresponding to the keyword. The keyword and the index may be mapped to be stored. In this case, when information on or regarding the keyword is identified in accordance with the keyword being input, the index corresponding to the keyword may be identified. Also, an index and answer content corresponding to the index may be mapped and stored in the memory 210. In this case, the answer content may be identified based on an identification of the index.

In some cases, the memory 210 may store a plurality of answer content and information on or regarding relationships between the answer content. For example, the memory 210 may store information on at least one of similarities between the plurality of answer content, relevancies between the plurality of answer content, and a priority according to the index. Based on the information on the relationships, more appropriate answer content according to the index may be provided.

The processor 220 may control an overall operation of the computing device 200. For example, the processor 220 may control elements of the computing device 200 based on an instruction stored in the memory 210, thereby controlling an operation of the computing device 200.

The processor 220 may acquire information on or regarding at least one keyword related to counseling. Specifically, the processor 220 may acquire information on at least one keyword related to counseling based on an input of the at least one keyword. The information on the at least one keyword related to the counseling may be acquired based on an input from an agent. However, it is merely an example, and the information may also be received from a device of the customer.

The processor 220 may identify information on or regarding an index corresponding to a keyword. The index may be composed of at least one of, for example, numbers, characters, and symbols. More specifically, for example, the index may be designated as “01” for a first keyword, designated as “02” for a second keyword, and designated as “a0” for a third keyword.

In some cases, a plurality of keywords related or similar to each other may exist. In such cases, the same index may be designated for each of the plurality of keywords. For example, information may be designated as “01” for both a delivery question keyword and a delivery inquiry keyword.

In the example embodiment, when the keyword is input from the agent, the processor 220 may provide an expected keyword in real time based on an input of at least some syllables of the keyword. For example, when a syllable “d” is input, the processor 220 may provide an expected keyword “delivery inquiry.” In this example, the agent may enter the keyword by clicking on the provided expected keyword. When an expected keyword is provided in plural, the processor 220 may provide a plurality of expected keywords. In this case, a keyword related to counseling may be input based on an input of selecting one of the plurality of expected keywords.

In the example embodiment, at least one keyword may be a plurality of keywords. For example, at least one keyword may include a main keyword and a sub-keyword. Here, the main keyword may be included in a first category related to the counseling, and the sub-keyword may be included in a second category corresponding to a detailed type related to the main keyword. For example, when the main keyword is “delivery inquiry”, the sub-keyword may be “delivery-completed”, “delivery ongoing”, “order processing”, or “out of stock” which are a detailed type related to delivery.

In this case, each of the main keyword and the sub-keyword may have a corresponding index. Accordingly, the processor 220 may identify a first index corresponding to the main keyword and a second index corresponding to the sub-keyword. The processor 220 may identify information on or regarding the index corresponding to the keyword based on the first index and the second index.

In an example, when at least one keyword includes the main keyword and the sub-keyword, the processor 220 may identify information on or regarding an index obtained by arranging the first index corresponding to the main keyword and the second index corresponding to the sub-keyword based on a predetermined order. The predetermined order may be, for example, an order in which an index corresponding to the main keyword is placed first and an index corresponding to the sub-keyword follows the index placed first. More specifically, for example, when the first index is “01” and the second index is “02”, an index may correspond to “0102.”

In the example embodiment, indices distinguished in the first category may be allocated to each of one or more keywords included in the first category related to the main keyword. Likewise, indices distinguished in the second category may be allocated to each of one or more keywords included in the second category related to the sub-keyword. In this case, depending on an embodiment, an overlapping index may be included in each category. For example, an index “01” may exist in each of the first category and the second category.

In the example embodiment, the processor 220 may display a title related to a counseling record and an answer content list related to an index based on information on or regarding the index. For example, when the information on the index is identified, the processor 220 may display an answer content list including answer content corresponding to the index. In this example, the information on the index may be identified automatically based on inputting of the index or identified based on an input of a user. The title related to the counseling record may include a text indicating the counseling that causes the input of the keyword. The answer content list may be a list of answer content corresponding to an answer to be provided to a customer in the counseling that causes the input of the keyword.

In the example embodiment, the processor 220 may determine a title related to a counseling record based on the identification of the index. For example, when the index is identified, the processor 220 may determine the title related to the counseling record using a phrase designated to correspond to the index. The processor 220 may display the determined title.

In the example embodiment, the processor 220 may display the answer content list related to the index based on the identification of the index. For example, when the index is identified, the processor 220 may identify at least one answer content related to the index. The processor 220 may generate an answer content list including the identified at least one answer content and display the generated answer content list. The processor 220 may select one answer content from the answer content list. In this instance, the selecting of the answer content may be performed based on an input of the agent but not be limited thereto. The processor 220 may display the selected answer content. The displayed answer content may include a keyword and an index. For example, when the keyword is “delivery inquiry” and the index is “01”, the displayed answer content may include a text “delivery inquiry-01.”

In the example embodiment, the processor 220 may display an answer content list including a predetermined number of answer content or less based on identification information of the agent related to the counseling. Specifically, the processor 220 may identify the identification information of the agent related to the counseling. The identification information of the agent may include information on or regarding at least one of a career of the agent and a task assigned to the agent.

The processor 220 may determine a number or quantity of answer content to be displayed in the answer content list based on the identification information of the agent. For example, when a career of the agent is less than a first period of time (e.g., 4 years), the processor 220 may determine the number of answer content to be displayed in the answer content list to be less than a first number or quantity (e.g., 3). When a career of the agent is greater than or equal to the first period of time, the processor 220 may determine the number of answer content to be displayed in the answer content list, to be greater than or equal to the first number and less than a second number or quantity (e.g., 20). In this case, if the number of identified answer content is less than the first number, the processor 220 may display all the identified answer content.

As another example, when the task assigned to the agent is related to a first task, the processor 220 may verify whether the first task is related to the identified index. The processor 220 may determine the number (or a range of numbers) of answer content to be displayed in the answer content list based on the identified relevancy.

When the first task is not related to the index, the processor 220 may determine the number of answer content to be displayed in the answer content list to be less than or equal to the first number (e.g., 3). When the first task is related to the index, the processor 220 may determine the number of answer content to be displayed in the answer content list, to be greater than the first number and less than the second number (e.g., 20).

The processor 220 may display the answer content list including at most the number of answer content determined based on the identification information of the agent.

In the example embodiment, each of the answer content included in the answer content list may have a priority corresponding to number information. In this case, the processor 220 may select answer content based on the number determined based on the identification information of the agent and the priorities of the answer content. Specifically, among a plurality of answer content identified based on the information on or regarding the index, the processor 220 may select answer content based on the number determined based on the identification information of the agent and the priorities of the answer content. For example, when ten answer content are identified based on the information on the index, and the number determined based on the identification information of the agent is less than three, the processor 220 may select three answer content having higher priorities from the ten answer content. The processor 220 may display an answer content list including the selected answer content.

In the example embodiment, the processor 220 may identify a period of time required to acquire the information on or regarding the keyword, starting from an initiation of the counseling based on a start input of the counseling being identified. The start input of the counseling may correspond to a wired or wireless call connection with the customer. In this instance, the processor 220 may identify the initiation of the counseling based on a connection with a terminal used for calling with the customer or an input from the agent. The processor 220 may identify a period of time used from a point in time at which the start input of the counseling is received or identified to a point in time at which the information on the keyword is acquired. The processor 220 may display the answer content list based on the identified period of time and the index. For example, when the identified period of time is less than a predetermined period of time (e.g., 5 minutes), the processor 220 may display an answer content list including the first number of answer content or less. When the identified period of time is greater than or equal to the predetermined period of time (e.g., 5 minutes), the processor 220 may display an answer content list including the second number of answer content or less. The first number may be greater than the second number. For example, the first number may be five and the second number may be one. Namely, when a keyword is input within a relatively short period of time, the processor 220 may display an answer content list including a greater number of answer content.

In some cases, the processor 220 may determine a response level of the agent based on the identified period of time. For example, when the identified period of time is less than a first period of time, the response level may be determined to be a first level. When the identified period of time is greater than or equal to the first period of time, the response level of the agent may be determined to be a second level. The processor 220 may display an answer content list based on the determined response level and the index. The number of answer content included in the answer content list may be previously designated based on the response level. The processor may display the answer content list such that the answer content list includes the predetermined number of answer content or less.

In the example embodiment, the processor 220 may verify whether at least one keyword is related to a counseling history of the agent. Specifically, the processor 220 may identify information on or regarding the counseling history of the agent to verify whether the agent has conducted counseling related to the keyword before. In this instance, information on a counseling history of the customer may be stored in the memory 210 in advance.

The processor 220 may display the answer content list based on the index and whether the acquired at least one keyword is related to the counseling history. Specifically, when the acquired at least one keyword is related to the counseling history of the agent, the processor 220 may display the first number of answer content or more among the plurality of answer content identified based on the information on the index. When a number of the plurality of answer content is less than the first number, all the plurality of answer content may be displayed.

The processor 220 may verify whether at least one keyword is related to the counseling history of the customer. Specifically, the processor 220 may identify information on the counseling history of the customer to verify whether the customer has been counseled in association with the keyword before. In this instance, information on the counseling history of the customer may be stored in the memory 210 in advance.

The processor 220 may display an answer content list based on the index and whether the acquired at least one keyword is related to the counseling history of the customer. Specifically, when the acquired at least one keyword is related to the counseling history of the customer, the processor 220 may display the first number of answer content or more among the plurality of answer content identified based on the information on the index. When a number of the plurality of answer content is less than the first number, all the plurality of answer content may be displayed. In this case, more detailed answers may be provided to the customer.

In the example embodiment, based on the information on the index, the processor 220 may display an answer content list including at least one of first answer content corresponding to the index, second answer content of which a similarity with the first answer content is greater than or equal to a predetermined value, or third answer content including an inquiry history associated with the first answer content. For example, the processor 220 may display an answer content list including the first answer content, the second answer content, and the third answer content. In this example, the first answer content may be exposed at the top, and the second answer content and the third content may be sequentially displayed below the first answer content based on a priority or relevancy. In this instance, the priority and the relevancy may be determined in advance. However, it is merely an example, and the second answer content and the third answer content may be displayed in an ascending order, in a descending order, or irrespective of an order.

In the example embodiment, the processor 220 may display answer content based on an input of selecting one answer content from the answer content list. In this case, the counseling history may be updated based on an answer content selecting input. For example, when the answer content selecting input is received in a state in which the counseling history is written based on the information on the index, the counseling history may be updated such that content related to the answer content is added thereto.

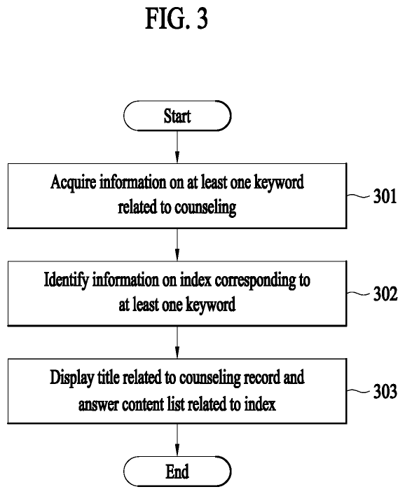

FIG. 3 is a flowchart illustrating an agent support method according to an example embodiment. Operations illustrated in FIG. 3 may be performed in different orders or irrespective of an order depending on cases. Since the descriptions made with reference to FIGS. 1 and 2 are also applicable here, repeated description of FIG. 3 will be omitted.

Referring to FIG. 3, in operation 310, a computing device may acquire information on or regarding at least one keyword related to counseling. For example, the computing device may acquire information on at least one keyword related to counseling based on an input received by an agent or information received from a customer. A keyword may be a word related to a topic of the counseling conducted between the customer and the agent.

In operation 320, the computing device may identify information on or regarding an index corresponding to the at least one keyword. The computing device may identify information on an index corresponding to the at least one keyword based on an identification of information on the keyword. The index may be generated as a combination (e.g., 01, 02, a1, a*) of at least one of numbers, characters, and symbols. However, it is merely an example, and the index may be generated in various ways.

In some cases, at least one keyword related to the counseling may be provided in plural. In such cases, the index may be generated based on a combination of indices corresponding to at least one keyword. When at least one keyword includes a main keyword and a sub-keyword, the index may be generated based on a combination of a first index corresponding to the main keyword and a second index corresponding to the sub-keyword. For example, the index may include an index (e.g., 0509) generated by arranging the first index (e.g., 05) and the second index (e.g., 09) in a predetermined order, but is not limited thereto.

In operation 330, the computing device may display a title related to a counseling record and an answer content list related to the index based on the information on or regarding the index. For the index, a related title may be designated in advance. Based on the designated title, when the information on the index is identified, the computing device may determine a title related to a counseling record and display the determined title.

When the information on or regarding the index is identified, the computing device may display the answer content list related to the index. As an example, when an index “01” is identified, the computing device may display an answer content list including predetermined answer content corresponding to “01.” As another example, when an index “0509” is identified, the computing device may display an answer content list including predetermined answer content corresponding to “0509.”

The answer content list related to the index may include at least one of first answer content corresponding to the index, second answer content of which a similarity with the first answer content is greater than or equal to a predetermined value, or third answer content including an inquiry history associated with the first answer content.

In the example embodiment, each of the each answer content may have a priority corresponding to number information. In this case, the computing device may determine at least one answer content based on a priority, generate an answer content list including the determined at least one answer content, and display the generated answer content list.

In some cases, the computing device may determine answer content to be provided based on identification information of an agent, a counseling history of the agent, and a counseling history of a customer and display an answer content list including the determined answer content. As an example, when a career of the agent is greater than or equal to a predetermined period of time based on the identification information of the agent, the computing device may determine a predetermined number of answer content among a plurality of answer content related to the index based on a priority and display an answer content list including the determined answer content.

As another example, when the counseling history of the agent includes a counseling history related to the keyword, or when the counseling history of the customer includes a counseling history related to the keyword, the computing device may determine a predetermined number of answer content among a plurality of answer content based on a priority and display an answer content list including the determined answer content.

In the example embodiment, the computing device may identify a period of time required to acquire the information on or regarding the keyword, starting from an initiation of the counseling based on a start input of the counseling being identified. When the identified period of time is within a predetermined time range, the computing device may determine a predetermined number of answer content based on a priority and display an answer content list including the determined answer content.

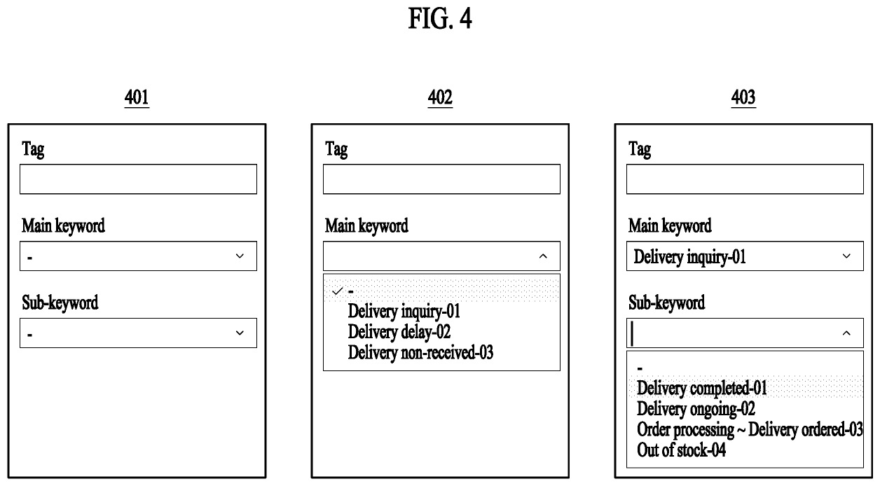

FIG. 4 is a diagram illustrating an example of acquiring a plurality of keywords when at least one keyword related to an agent support method is provided in plural according to an example embodiment.

Reference numeral 401 of FIG. 4 indicates a screen area for inputting a keyword related to counseling according to an initiation of the counseling. An area corresponding to a tag of the reference numeral 401 may be an area for inputting tag information input to facilitate a search of a counseling record. Tag information may be mapped to a counseling record in a case in which a text is input to a tag when generating the counseling record according to an example embodiment of the present disclosure.

When a main keyword field is blank as indicated by the reference numeral 401, in response to an input, for example, a click input, to the main keyword field being received, a computing device may provide a list of various input keywords as indicated by reference numeral 402. When an input of selecting a keyword, for example, “delivery inquiry” from the keywords of the list is received, the computing device may determine a main keyword to be the delivery inquiry and display the keyword in the main keyword field as indicated by reference numeral 403.

In the example embodiment, referring to FIG. 4, the computing device may provide a sub-keyword field along with the main keyword field based on a case in which a plurality of keywords is possible to be input. When the main keyword is selected, a list of keywords possible to be input to the sub-keyword may be displayed as indicated by the reference numeral 403. The sub-keyword may be a keyword included in a second category corresponding to a detailed type of a first category related to the main keyword. In this case, the sub-keyword may be a subordinate type of the main keyword.

Referring to FIG. 4, the keyword may be displayed along with an index (e.g., 01, 02, 03, and 04). Since the index may be designated for each category, the same index may be designated for keywords included in different categories as indicated by the reference numeral 403. In some cases, displaying the index may be omitted.

When the plurality of keywords is identified as illustrated in FIG. 4, the computing device may provide an agent with a screen as shown in FIG. 5.

FIG. 5 is a diagram illustrating an example of identifying an index when at least one keyword related to an agent support method is provided in plural according to an example embodiment.

Referring to FIG. 5, a main keyword and a sub-keyword may be displayed in a first area 501 when information on or regarding a plurality of keywords is identified in accordance with the main keyword and the sub-keyword being input as shown in FIG. 4. A computing device may identify information on an index based on an identification of the main keyword and the sub-keyword. For example, as illustrated, the main keyword may be identified as “delivery inquiry-01” and the sub-keyword may be identified as “delivery completed-01.” In this example, the index may be identified (or generated) as a combination of a first index (e.g., 01) corresponding to the main keyword and a second index (e.g., 02) corresponding to the sub-keyword. That is, the index may correspond to “0101.”

The identified index may be displayed in a second area 502. The index may be automatically displayed based on the identification of the main keyword and the sub-keyword. However, it is merely an example, and the index may also be displayed based on an input of a user. As described below, answer content corresponding to a final index may be displayed based on an identification of the final index.

The keyword may be displayed in the first area 501 may be selected from a drop-down type list and then displayed.

As illustrated, information on or regarding a keyword indicated by the index may be displayed together in the second area 502. The keyword indicated by the index may correspond to the keyword of the first area 501 but is not limited thereto. In some cases, help 503 may be displayed together for smooth use of the agent support method.

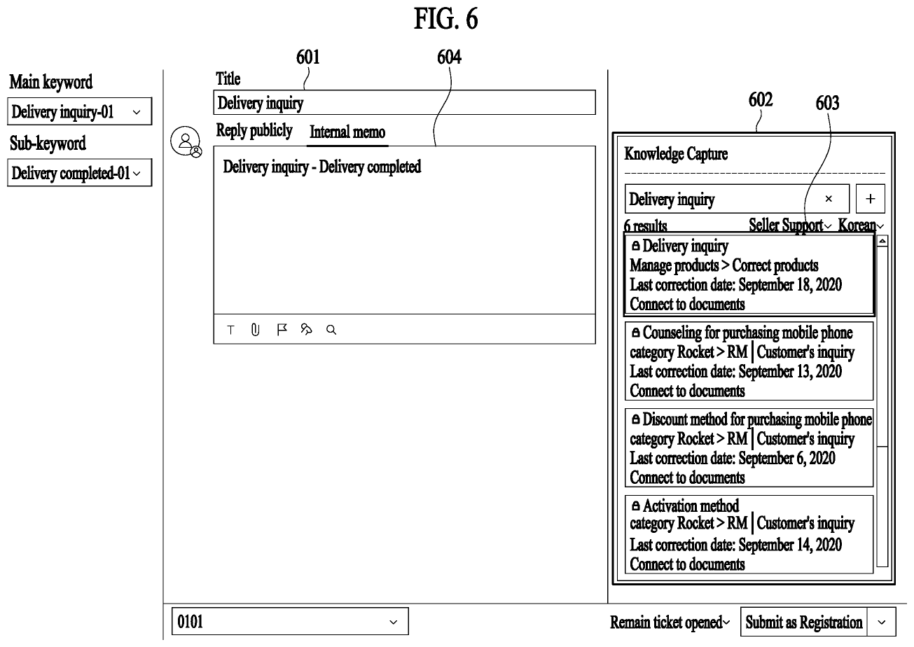

In the example embodiment, when the information on the index is identified, the computing device may provide a screen as shown in FIG. 6.

FIG. 6 is a diagram illustrating an example of displaying a title related to a counseling record and an answer content list when at least one keyword related to an agent support method is provided in plural according to an example embodiment.

Referring to FIG. 6, a title 601 related to a counseling record and an answer content list 602 related to an index may be displayed based on information on or regarding the index. The answer content list 602 may include answer content 603 corresponding to the index. The answer content 603 corresponding to the index may be set to be displayed at a top of the answer content list 602.

In the example embodiment, the answer content 603 may be designated in advance based on the index. In this case, the answer content 603 may be displayed in accordance with the index or final index (e.g., 0101) being identified.

In the example embodiment, a variety of relevant answer content may be further displayed in addition to the answer content 603 corresponding to the index as shown in FIG. 6. In some cases, answer content displayed in the answer content list 602 may be preview content that briefly shows the answer content.

In the example embodiment, a computing device may provide a counseling record area 604 for generating a counseling record. Based on an identification of information on the index, content corresponding to the index, for example, a keyword may be recorded in the counseling record area 604.

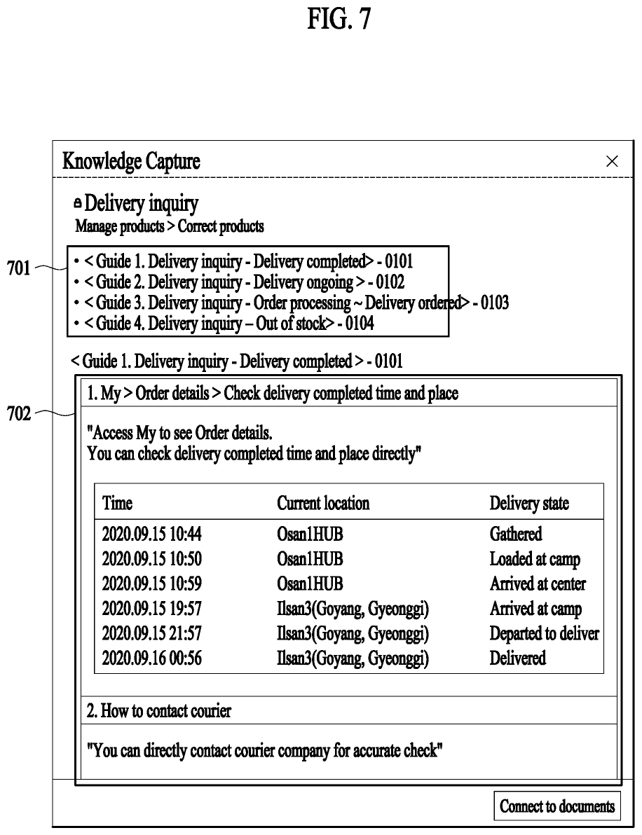

The computing device may receive an input of selecting one answer content from the answer content list 602. In this case, the computing device may provide a screen as shown in FIG. 7.

FIG. 7 is a diagram illustrating an example of displaying answer content when at least one keyword related to an agent support method is provided in plural according to an example embodiment. Specifically, FIG. 7 illustrates an example of a screen displayed when the answer content 603 corresponding to the index is selected from the answer content list 602 of FIG. 6.

Referring to FIG. 7, in response to answer content 702 being selected from an answer content list, a computing device may display the answer content 702 in greater detail. In some cases, the computing device may provide link information 701 for displaying a plurality of answer content included in the answer content list. When a link included in the link information 701 is selected, answer content corresponding to the selected link may be displayed. However, it is merely an example, and a link may be omitted depending on an embodiment.

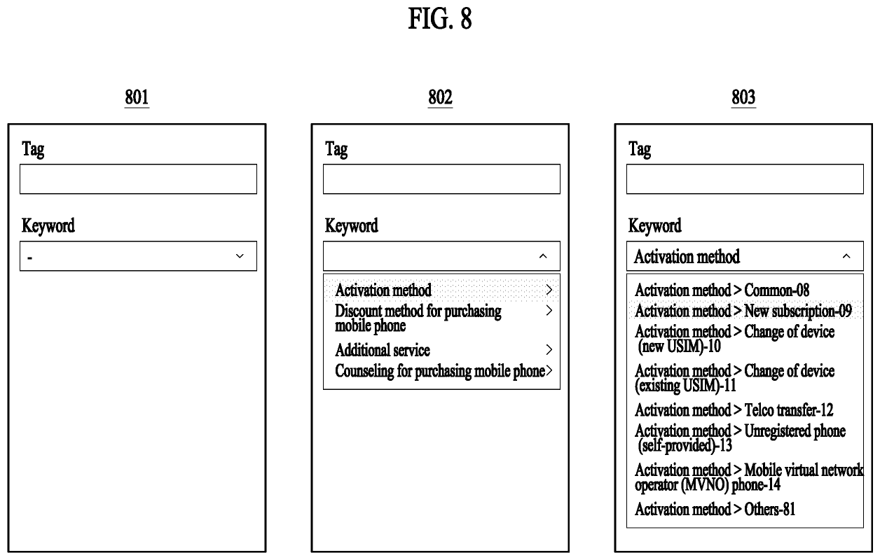

FIG. 8 is a diagram illustrating an example of acquiring a keyword when at least one keyword related to an agent support method is provided as a single keyword according to an example embodiment. Content overlapping the description of FIGS. 4 through 7 will be omitted.

Reference numeral 801 of FIG. 8 indicates a screen area for inputting a keyword related to counseling in accordance with the counseling being initiated. When a keyword area is blank as indicated by the reference numeral 801, in response to an input, for example, a click input, to the keyword area being received, a computing device may display information for selecting a keyword as indicated by reference numeral 802. The information for selecting the keyword may be designated in advance.

When one of the information for selecting the keyword is selected, at least one keyword related to the selected information may be displayed as indicated by reference numeral 803. When “activation method” is selected from the information for selecting the keyword, at least one keyword, for example, “common”, “new subscription”, and “change of device (new USIM)” related to “activation method” may be displayed as shown by reference numeral 803.

The computing device may receive an input of selecting one of the at least one keyword. When the input is received, the computing device may acquire information on or regarding the keyword. Based on an acquisition of the information on the keyword, the computing device may provide a screen as shown in FIG. 9.

FIG. 9 is a diagram illustrating an example of identifying an index when at least one keyword related to an agent support method is provided as a single keyword according to an example embodiment.

Referring to FIG. 9, a computing device may display a keyword in a first area 901 according to an acquisition of information on the keyword. The computing device may display an index in a second area 902 based on an identification of information on the index corresponding to the keyword.

In the example embodiment, information on a keyword indicated by the index may also be displayed in the second area 902. The keyword indicated by the index may correspond to the keyword of the first area 901 but is not limited thereto. In some cases, help 903 may also be displayed for smooth use of the agent support method.

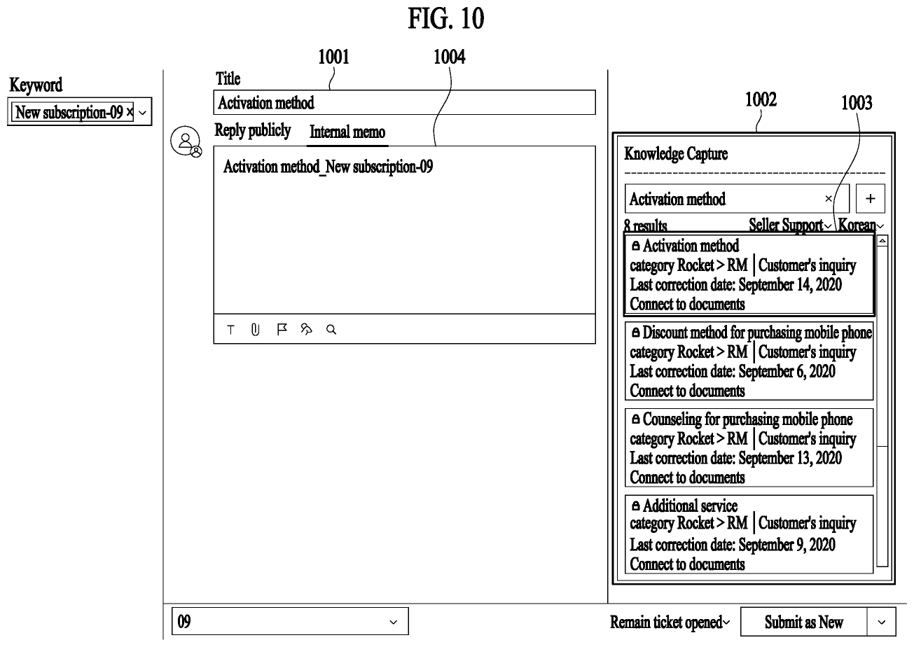

In the example embodiment, when the information on or regarding the index is identified, the computing device may display a screen as shown in FIG. 10.

FIG. 10 is a diagram illustrating an example of displaying a title related to a counseling record and an answer content list when at least one keyword related to an agent support method is provided as a single keyword according to an example embodiment.

Referring to FIG. 10, a title 1001 related to a counseling record and an answer content list 1002 related to an index may be displayed based on information on the index. The answer content list 1002 may include answer content 1003 corresponding to the index. The answer content 1003 corresponding to the index may be set to be displayed at a top of the answer content list 1002.

In the example embodiment, a variety of relevant answer content may be further displayed in addition to the answer content 1003 corresponding to the index as shown in FIG. 10. In some cases, answer content displayed in the answer content list 1002 may be preview content that briefly shows the answer content.

In the example embodiment, a computing device may provide a counseling record area 1004 in which content corresponding to the index is recorded. The content corresponding to the index may include a keyword, for example, “new subscription” but is not limited thereto. The content corresponding to the index may also include content designated in relation to the index, for example, “activation method.”

According to the present disclosure, an agent support method and a computing device thereof may provide answer content using information on or regarding an index identified based on at least one keyword related to counseling so that a customer service is quickly provided and a work efficiency of an agent is improved.

Further, according to the present disclosure, an agent support method and a computing device thereof may provide a more suitable answer content list for each agent based on characteristics of an agent, for example, a career of the agent, assigned task information, and a counseling history, thereby improving the work efficiency of the agent.

The electronic device described herein may include a permanent storage such as a disk drive, a communication port for handling communications with external devices, and user interface devices such as a touch panel, a key, and a button. The methods that are implemented as software modules or algorithms may be stored as program instructions or computer-readable codes executable by the processor on a computer-readable recording medium. Here, examples of the computer-readable recording medium include magnetic storage media (e.g., read only memory (ROM), random access memory (RAM), floppy disk, or hard disk), optically readable media (e.g., compact disk-read only memory (CD-ROM) or digital versatile disk (DVD)), etc. The computer-readable recording medium may be distributed over network coupled computer systems, and thus, the computer-readable code may be stored and executed in a distributed fashion. This medium may be read by the computer, stored in the memory, and executed by the processor.

The present embodiments may be described in terms of functional block components and various processing steps. Such functional blocks may be realized by any number of hardware and/or software components configured to perform specified functions. For example, embodiments may employ various integrated circuit (IC) components, e.g., memory elements, processing elements, logic elements, look-up tables, and the like, which may carry out a variety of functions under the control of one or more microprocessors or other control devices. Similarly, where the elements are implemented using software programming or software elements, the present embodiments may be implemented with any programming or scripting language such as C, C++, Java, assembler language, or the like, with the various algorithms being implemented with any combination of data structures, objects, processes, routines or other programming elements. Functional aspects may be implemented in algorithms that are executed on one or more processors. Furthermore, the embodiments described herein could employ any number of conventional techniques for electronics configuration, signal processing and/or control, data processing and the like. The terms “mechanism,” “element,” “means,” and “configuration” are used broadly and are not limited to mechanical or physical embodiments. These terms may include meaning of a series of routines of software in association with a processor, for example.

The above-described embodiments are merely examples, and other embodiments may be implemented within the scope of the following claims.

1. A method of supporting an agent via a computing device, the method comprising:
generating, by the computing device, a mapping of a plurality of keywords to a plurality of indices, each index of the plurality of indices corresponding to a set of answer content;
storing, in memory of the computing device, the mapping of the plurality of keywords to the plurality of indices;
identifying, by the computing device, an initiation of a wired or wireless connection between a customer computing device and an agent computing device of the agent, the initiation of the wired or wireless connection corresponding to a request for counseling;
identifying, by the computing device from the memory, one or more keywords of the plurality of keywords based on the request for counseling;
identifying, by the computing device, one or more indices of the plurality of indices corresponding to the one or more keywords;
obtaining, by the computing device, information associated with the agent, the information associated with the agent comprising a counseling history of the agent; and
causing, by the computing device, the agent computing device to display a counseling record and a particular set of answer content corresponding to the one or more indices in a format based on the information associated with the agent, wherein a quantity of the answer contents is equal to or less than a predetermined value determined based on the information associated with the agent.

2. The method of claim 1, wherein the one or more keywords comprises a main keyword and a sub-keyword, wherein:
the main keyword corresponds to a first category of keywords related to counseling,
the sub-keyword corresponds to a second category of keywords corresponding to a detailed type related to the main keyword, and
the one or more indices are identified based on a first index corresponding to the main keyword and a second index corresponding to the sub-keyword.

3. The method of claim 2, wherein a first subset of the plurality of indices corresponding to the first category of keywords are respectively mapped to one or more first keywords included in the first category of keywords, and
wherein a second subset of the plurality of indices corresponding to the second category of keywords are respectively mapped to one or more second keywords included in the second category of keywords.

4. The method of claim 1, wherein the one or more keywords comprises a main keyword and a sub-keyword, wherein the one or more indices are generated by arranging a first index corresponding to the main keyword and a second index corresponding to the sub-keyword based on a predetermined order.

5. The method of claim 1, further comprising:
selecting answer content from the particular set of answer content; and
displaying the answer content,
wherein the answer content comprises the one or more keywords and the one or more indices.

6. (canceled)

7. The method of claim 1, wherein the information associated with the agent further comprises one or more of assigned task information of the agent, experience information of the agent, and career information of the agent.

8. The method of claim 1, wherein each answer content of the particular set of answer content comprises a priority corresponding to quantity information, and
wherein causing the agent computing device to display the particular set of answer content comprises causing the agent computing device to display the particular set of answer content comprising answer content selected based on the quantity information and the priority of each answer content.

9. The method of claim 1, further comprising:
identifying a period of time required to identify the one or more keywords, where a start of the period of time corresponds to the initiation of the wired or wireless connection between the customer computing device and the agent computing device of the agent based on a start input of the counseling being identified,
wherein causing the agent computing device to display the particular set of answer content comprises causing the agent computing device to display the particular set of answer content based on the period of time and the one or more indices.

10. The method of claim 1, further comprising:
verifying whether the one or more keywords are related to the counseling history of an agent,
wherein causing the agent computing device to display the particular set of answer content comprises causing the agent computing device to display the particular set of answer content based on the one or more indices and whether the one or more keywords are related to the counseling history of the agent.

11. The method of claim 1, further comprising:
verifying whether the one or more keywords are related to a counseling history of a customer,
wherein causing the agent computing device to display the particular set of answer content comprises causing the agent computing device to display the particular set of answer content based on the one or more indices and whether the one or more keywords are related to the counseling history of the customer.

12. The method of claim 1, wherein the particular set of answer content comprises at least one of a first answer content corresponding to the one or more indices, a second answer content, wherein the second answer content has a similarity with the first answer content greater than a predetermined value, or a third answer content comprising an inquiry history associated with the first answer content.

13. A non-transitory computer-readable recording medium comprising a computer program for performing the method of claim 1.

14. A computing device for supporting an agent, the device comprising:
a memory comprising instructions; and
a processor, wherein the processor is connected to the memory and configured to:
generate a mapping of a plurality of keywords to a plurality of indices, each index of the plurality of indices corresponding to a set of answer content;
store, in the memory, the mapping of the plurality of keywords to the plurality of indices;
identify an initiation of a wired or wireless connection between a customer computing device and an agent computing device of the agent, the initiation of the wired or wireless connection corresponding to a request for counseling;
identify, from the memory, one or more keywords of the plurality of keywords based on the request for counseling;
identify one or more indices of the plurality of indices corresponding to the one or more keywords;
obtain information associated with the agent, the information associated with the agent comprising a counseling history of the agent; and
cause the agent computing device to display a counseling record and a particular set of answer content corresponding to the one or more indices in a format based on the information associated with the agent, wherein a quantity of the answer contents is equal to or less than a predetermined value determined based on the information associated with the agent.
